(19) United States
(12) Patent Application Publication
(10) Pub. No.: US 2026/0138179 A1
(43) Pub. Date: May 21, 2026

(54) METHOD FOR MANUFACTURING HIGH-FREQUENCY FUNCTIONAL STRUCTURES, AND HIGH-FREQUENCY FUNCTIONAL STRUCTURE

(71) Applicant: GOLDEN DEVICES GMBH, Erlangen (DE)

(72) Inventors: Mark SIPPEL, Fürth (DE); Konstantin LOMAKIN, Nürnberg (DE); Gerald GOLD, Erlangen (DE); Andreas HOFMANN, Erlangen (DE); David PANUSCH, Erlangen (DE); Lucas Peter PELCHEN, Forchheim (DE); Fabian TEICHMANN, Nürnberg (DE); Sebastian MÜLLER, Plauen (DE)

(21) Appl. No.: 18/998,396

(22) PCT Filed: Jul. 25, 2023
(86) PCT No.: PCT/EP2023/070517

§ 371 Date: Feb. 6, 2026

(30) Foreign Application Priority Data
Jul. 25, 2022 (DE) 10 2022 118 574.5

(51) Int. Cl. B22D 25/02; B22C 9/22; B33Y 80/00

(52) U.S. Cl. CPC B22D 25/02; B22C 9/22; B33Y 80/00

(57) ABSTRACT

The present invention relates to a method for producing high-frequency functional structures comprising the following steps: —producing a replica of the functional structure; —forming the replica into a molding material; —removing the replica from the molding material, with the result that a casting mold is produced; —pouring melt into the casting mold; —demolding of the solidified melt, wherein over 90%, preferably over 95%, in particular over 99% of the mass of the image consists of a pure material.

### CROSS REFERENCE TO RELATED APPLICATIONS

The present application is a U.S. National Phase of International Application No. PCT/EP2023/070517 entitled “METHOD FOR PRODUCING HIGH-FREQUENCY FUNCTIONAL STRUCTURES, AND HIGH-FREQUENCY FUNCTIONAL STRUCTURE,” and filed on Jul. 25, 2023. International Application No. PCT/EP2023/070517 claims priority to German Patent Application No. 10 2022 118 574.5 filed on Jul. 25, 2022. The entire contents of each of the above-listed applications are hereby incorporated by reference for all purposes.

### TECHNICAL FIELD

The present invention relates to a method for manufacturing high-frequency functional structures, comprising the steps:
Producing a replica of the functional structure;
Embedding the replica in a mold material;
Expelling the replica from the mold material such that a casting mold is formed;
Pouring a melt into the casting mold;
Demolding the solidified melt.

### BACKGROUND AND SUMMARY

From the prior art it is known to manufacture high-frequency functional structures by machining processes such as turning or milling. In doing so, a required geometric complexity of the functional structure can only be achieved with great effort. The functional structures are usually produced by the elaborate split-block method, and miniaturization of the functional structures is likewise only possible with high effort.

It is also known to manufacture high-frequency functional structures by metal printing, such as selective laser melting (SLM). A disadvantage of this approach is the rough surfaces as well as limitations in geometric complexity, since support structures are used early in the process. The raw materials for SLM, which can be in the form of powder or filament, are inefficient in terms of energy consumption and material utilization.

It is further known to produce a base body from plastic and then metallize it such that a high-frequency functional structure results. The disadvantage here is the poor thermal stability at high electrical power. In addition, plastic-based bodies in most cases have worse mechanical stability compared to their metallic counterparts.

It is also known to produce high-frequency functional structures using casting techniques.

Preferred properties of high-frequency functional structures are a smooth surface, to reduce losses, and a high geometric precision with high geometric complexity. This minimizes reflections of electromagnetic waves in the functional structure and ensures that the emission of an electromagnetic wave occurs as desired when using the functional structure as an antenna. Similarly, a high-frequency functional structure is preferably designed such that electromagnetic waves at the highest possible frequencies can be guided through the functional structure with acceptable attenuation. In particular at high electrical power, good thermal stability of the geometry is to be pursued. Fundamentally, a sufficient mechanical strength is desired.

Against this background, the present invention has the objective of providing a method for manufacturing high-frequency functional structures with optimized properties.

This object is achieved by a method as described herein.

Accordingly, it is provided according to the invention that over 90%, preferably over 95%, in particular over 99% of the mass of the replica consist of a pure substance.

The material of which the replica is made thus comprises more than 90%, preferably more than 95%, in particular more than 99% of one pure substance. The remainder of the mass of the replica is formed by other substances.

The present invention further relates to a method for manufacturing high-frequency functional structures having the features described herein. According to this, the following steps are provided:
Producing a replica of the functional structure;
Embedding the replica in a mold material;
Expelling the replica from the mold material such that a casting mold is formed;
Pouring a melt into the casting mold;
Demolding the solidified melt, wherein

the functional structure and/or the replica is a slotted waveguide and/or a waveguide with non-radiating openings and/or an RF component derived from one of these. Such a component can e.g. be a component which comprises one (or multiple) slotted waveguides and/or one (or multiple) waveguides with non-radiating openings.

It is also conceivable and encompassed by the invention to combine features of different embodiments.

The casting mold can be a permanent mold. The mold can include a core, preferably produced additively.

Likewise, it is provided according to the invention that the functional structure is a slotted waveguide.

The replica is preferably an ideally exact copy of the functional structure.

For casting reasons, it is preferable that, in addition to the replica, a gating system is molded into the mold material.

This gating system serves in particular to expel the replica from the mold material and to pour the melt into the casting mold.

Preferably, the term “gating system” denotes structures such as openings and channels in the mold, as well as the corresponding structures that are molded in and thus form those openings and channels, as well as the solidified melt in these channels and openings.

The gating system is preferably removed after demolding the solidified melt so that the functional structure is obtained.

The gating system and the replica are preferably referred to as the model.

A slotted waveguide preferably has slots or openings in or on its side walls that are non-radiating and smaller than the guided wavelength. The slots or openings facilitate washing out of the wax replica, i.e. the removal of support structures from the interior and, especially in the case of complex geometries, the removal of the mold. Through these openings, the respective materials and process media can flow in and/or out.

In a slotted waveguide, it is preferably a waveguide in which openings are provided in the outer wall that do not lead to radiation. This is the case if the openings are small relative to the guided wavelength and/or do not cut the current density associated with the wave in the waveguide on the conductive wall transversely to its flow direction.

Preferably, in rectangular waveguides, these openings are provided in the narrow sides of the waveguide.

Preferably, it is provided that the replica is produced by an additive process, preferably a multi-component printing process, and in particular the multi-jet printing process.

The replica can be produced by an additive process, preferably a stereolithographic, resin-based and/or filament printing process, and/or by selective laser sintering.

It can be provided that support structures are arranged on the replica, wherein the support structures consist at least partially of a material different from the material of the replica, or consist of the same material as the replica.

The support structures can preferably be removed by chemical washing. For example, the material of the support structures can be a material that is dissolved in methanol and/or isopropanol and/or another solvent.

Preferably, it is provided that the support structures of the replica required for additive manufacturing are removed before embedding the replica in a mold material.

The multi-component printing can, for example, be a two-component printing and is also referred to as multi-jet printing.

The replica can also be produced by selective laser sintering (SLS), stereolithography (SLA), or by molding (for example, injection molding). The replica can also be created by FDM (fused deposition modeling), i.e. a filament melting process.

Preferably, it is provided that the pure substance is wax, plastic, tin or lead, or another metal.

In an embodiment where the pure substance is wax and the replica is produced by multi-component printing, electromagnetic waves with significantly higher frequencies can be guided through the manufactured functional structures with lower losses than in functional structures produced by prior art methods.

It is conceivable that the replica is expelled from the mold without residue.

By “without residue” is preferably meant that the residues of the replica in the mold amount to less than 10%, preferably less than 5% or less than 1% of the mass of the replica, or that the replica is completely expelled from the mold material.

A high purity of the replica-i.e. a replica where over 90%, preferably over 95%, in particular over 99% of its mass consists of a pure substance-advantageously enables an expelling process that is tuned exactly to this pure substance. Thus, parameters for expelling, such as temperature or atmosphere, can be adjusted precisely to the pure substance. This in turn enables expelling in such a way that no or only negligible residues of the pure substance remain in the mold.

Preferably, the slots of the slotted waveguide facilitate the creation of the mold, especially on the inner sides of the slotted waveguide replica.

Preferably, it is provided that a region of the surface or the entire surface of the replica and/or the mold and/or the functional structure is smoothed.

The smoothing can be performed, for example, subtractively and/or additively, and preferably galvanically (electrolytically).

A post-treatment in the form of smoothing the replica, the mold, or the functional structure can be provided to improve the high-frequency properties of the functional structure.

The smoothing can be done by material removal, for example by means of a multiphase fluid or by a gas with solid particles.

The smoothing can be done by material deposition, for example by metal deposition.

Smoothing can also be done by deforming the surface, for example by blasting such as sandblasting, shot peening or dry ice blasting.

The smoothing can be performed at any point in the process.

Preferably, the slots of the slotted waveguide facilitate smoothing of the inner sides of the slotted waveguide.

Preferably, it is provided that before or during the filling of the melt, at least one of the following steps is carried out:
Evacuating the mold;
Filling the mold with protective gas.

Preferably, the slots of the slotted waveguide facilitate the filling of the melt or improve its accessibility to the inner sides of the slotted waveguide.

Filling the mold with protective gas can be done at a gas pressure of about 2 bar. It is also possible to provide multiple flushing of the mold with protective gas before or during the filling of the melt.

Advantageously, no residues remain in the mold or in the mold cavity. Finer structures are possible, and none or only such a number of shrinkage cavities (voids) are present that there are no functional impairments of the functional structure. Reactive metals can also be processed, since no oxygen is present in the mold.

Protective gases are, for example, noble gases such as argon.

It can be provided that before or during the filling of the melt, pressure is applied to the melt.

It is conceivable that the mold material is or comprises plaster and/or salt and/or sand and/or concrete and/or silicon and/or one or more phosphate-bound materials.

It is further conceivable that the melt or the functional structure comprises one or more of the following metals: aluminum, copper, steel, silver, tin, zinc, bronze, brass, gold, titanium, and/or magnesium.

Preferably, it is provided that the functional structure is a high-frequency transmission line, in particular a waveguide (preferably slotted), or an antenna, in particular a horn, helix or waveguide slot antenna, or a filter, or a resonator, or a coupler, or some other passive RF component, or comprises one or more of these components.

The invention also relates to a high-frequency functional structure that is partially or fully manufactured by a method according to the invention.

In particular, compared to metal printing, a casting process has several advantages. A significantly wider range of metals can be processed. More complex and finer structures are possible. The surface roughness is lower. The material quality is higher, since the final product is solid material.

By using a material of high purity, the replica is preferably reproduced more accurately in the mold material or investment compound. The surface quality and roughness are preferably significantly improved as well.

The functional structure is preferably monolithic and metallic.

It is conceivable that the non-radiating openings of the slotted waveguide are arranged along the propagation direction at intervals smaller than one guided wavelength, and/or that their size is smaller than half of the guided wavelength.

Furthermore, it can be provided that when removing the support structures of the replica, the support material is washed out through the non-radiating openings of the slotted waveguide, or that the removal is at least facilitated by these openings.

In a further embodiment of the invention, it is provided that during embedding of the replica in the mold material, the mold material enters the interior of the slotted waveguide replica through the non-radiating openings, or that this entry is at least facilitated thereby.

During demolding of the mold material to be removed, it can be provided that the mold material exits through the non-radiating openings of the slotted waveguide, or that the exit is at least facilitated thereby.

It is further conceivable that the gating structures required for metal casting are attached at locations of the RF component where no relevant RF functionality is required, and in particular on the outer sides of the waveguide or the waveguide component.

It is noted at this point that the terms “one” and “a” do not necessarily refer to exactly one single element (although this is one possible embodiment), but can also denote a plurality of the elements. Likewise, the use of the plural also includes the presence of the element in the singular, and vice versa, the singular encompasses multiple instances of the element in question. Furthermore, all features of the invention described herein can be combined with one another or claimed in isolation in any given permutation.

It is further noted that the term “waveguide” encompasses not only the waveguide as such, but also RF components (for example, antennas) that have such a waveguide. The invention is thus not limited to the manufacture of a waveguide per se, but also encompasses the manufacture of structures that have at least one waveguide.

Further advantages, features and effects of the present invention will become apparent from the following description of preferred exemplary embodiments.

One exemplary embodiment relates to a slotted waveguide that is manufactured using the inventive method.

A slotted waveguide is a box-shaped conductor that has slots on its side walls.

First, a replica of the slotted waveguide is produced, which consists of over 99% by mass of a pure wax.

The replica is produced, for example, in a 3D printing process. For technical reasons, in 3D printing, depending on the geometry of the printed product, it is necessary to support incomplete sections with support structures.

These support structures can now be designed such that they partially serve as a gating system or are partially removed before embedding the replica.

In this example, parts of the support structures are used as the gating system and other parts are washed out. The parts that are washed out are made of a material that is soluble in methanol.

The washing out is carried out, for example, by immersing the printed product in methanol and dissolving the part of the support structures that is made of a methanol-soluble material.

The replica with the gating system can be referred to as the model.

The model is then embedded in a mold material that contains or is plaster. When embedding the plaster, it can enter the interior of the slotted waveguide more easily through the slots of the slotted waveguide.

The plaster is then cured. The curing can take place by air drying.

The curing can additionally take place by firing the plaster.

After curing, or before or during firing, the model is expelled from the plaster. For this purpose, the plaster and the model are heated to a temperature at which the wax melts, for example above 40° C.

The model then melts and the wax runs out of the plaster, leaving a mold cavity. The exit of the wax from the inner areas of the model is again facilitated by the slots in the slotted waveguide.

The mold cavity is then flushed with argon, so that the air or oxygen is displaced from the mold cavity. Prior to this, smoothing of the mold cavity by blowing it out with a gas mixed with abrasive particles may have been carried out.

The mold cavity, which is partially enclosed by plaster, is then filled with a melt of an aluminum alloy.

This melt is then subjected to a pressure of about 2 bar, so that the melt is pressed into the entire mold cavity. The entry of the melt into the interior of the slotted waveguide is again facilitated by the slots of the slotted waveguide.

After the melt cools, the plaster mold is destroyed and the cooled casting is demolded. During demolding, the slots of the slotted waveguide facilitate the removal of the plaster mold from the interior of the slotted waveguide.

Then the gating system is removed from the functional structure.

A post-processing of the functional structure in the form of smoothing the surface can follow.

1. A method for manufacturing high-frequency functional structures, comprising the steps:
producing a replica of a functional structure;
embedding the replica in a mold material;
expelling the replica from the mold material such that a casting mold is formed;
pouring a melt into the casting mold; and
demolding the solidified melt;
wherein more than 90%, of the mass of the replica consists of a pure substance.

2. A method for manufacturing high-frequency functional structures, comprising the steps:
producing a replica of a functional structure;
embedding the replica in a mold material;
expelling the replica from the mold material such that a casting mold is formed;
pouring a melt into the casting mold; and
demolding the solidified melt;
wherein the functional structure and/or the replica is a slotted waveguide and/or a waveguide with non-radiating openings and/or an RF component derived from one of these.

3. The method according to claim 1, wherein the functional structure and/or the replica is a slotted waveguide and/or a waveguide with non-radiating openings and/or an RF component derived from one of these.

4. The method according to claim 1, wherein the replica is produced by an additive process.

5. The method according to claim 1, wherein the replica is produced by an additive process and/or by selective laser sintering.

6. The method according to claim 2, wherein support structures are arranged on the replica, wherein the support structures consist at least partially of a material different from the material of the replica, or consist of the same material as the replica.

7. The method according to claim 6, wherein the support structures of the replica required for additive manufacturing are removed before embedding the replica in a mold material.

8. The method according to claim 6, wherein the support structures are washed out with a solvent,

9. The method according to claim 1, wherein the pure substance is wax, plastic, tin or lead, or another metal.

10. The method according to claim 1, wherein the replica is expelled from the casting mold without residue.

11. The method according to claim 1, wherein a region of the surface or the entire surface of the replica and/or the mold and/or the functional structure is smoothed.

12. The method according to claim 11, wherein the smoothing is performed subtractively and/or additively.

13. The method according to claim 1, wherein before or during the filling of the melt, at least one of the following steps is carried out:
evacuating the mold; and
filling the mold with protective gas.

14. The method according to claim 1, wherein after or during the filling of the melt, pressure is applied to the melt.

15. The method according to claim 1, wherein the mold material comprises, plaster, salt, sand, concrete, silicon, or one or more phosphate-bound materials.

16. The method according to claim 1, wherein the melt or the functional structure comprises aluminum, copper, steel, silver, tin, zinc, bronze, brass, gold, titanium and/or magnesium, or another metal.

17. The method according to claim 2, wherein the non-radiating openings of the slotted waveguide are arranged along the propagation direction at intervals smaller than one guided wavelength, and that their size is smaller than half of the guided wavelength.

18. The method according to claim 6, wherein when removing the support structures of the replica, the support material is washed out through the non-radiating openings of the slotted waveguide, or the removal is facilitated thereby.

19. The method according to claim 2, wherein during embedding of the replica in the mold material, the mold material enters the interior of the replica of the slotted waveguide through the non-radiating openings, or the entry is facilitated thereby.

20. The method according to claim 2, wherein during demolding of the mold material to be removed, the mold material exits through the non-radiating openings of the slotted waveguide, or the exit is facilitated thereby.

21. The method according to claim 2, wherein the gating structures required for metal casting are attached at locations of the RF component where no relevant RF functionality is required.

22. The method according to claim 1, wherein the functional structure is a high-frequency transmission line, an antenna, a filter or a resonator or a coupler or another passive RF component, or comprises one or more of these components.

23. A high-frequency functional structure that is partially or completely manufactured by the method according to claim 1.
